(19) United States
(12) Patent Application Publication
(10) Pub. No.: US 2023/0297249 A1
(43) Pub. Date: Sep. 21, 2023

(54) STORAGE SYSTEM AND METHOD OF CONTROLLING STORAGE SYSTEM

(71) Applicant: Hitachi Information & Telecommunications Engineering, Ltd., Yokohama-shi (JP)

(72) Inventors: Tomohiro MIYABE, Yokohama (JP); Toshiaki Hayano, Yokohama (JP); Junji Ogawa, Yokohama (JP); Hiroshi Otsuru, Yokohama (JP)

(73) Assignee: Hitachi Information & Telecommunications Engineering, Ltd., Yokohama-shi (JP)

(21) Appl. No.: 18/181,747

(22) Filed: Mar. 10, 2023

(30) Foreign Application Priority Data
Mar. 18, 2022 (JP) 2022-043449

(51) Int. Cl. G06F 3/06

(52) U.S. Cl. CPC G06F 3/0619; G06F 3/0659; G06F 3/0679

(57) ABSTRACT

Instead of blocking a storage device low in performance of I/O processing due to execution of restoration processing along with occurrence of a failure of a non-volatile storage element, the storage device is kept used. A storage system comprises storage devices and a storage controller. The storage devices each include a plurality of non-volatile storage elements. The storage devices each is configured to: receive an I/O command from the storage controller; and transmit, when one of the storage devices detects a failure in one of the plurality of non-volatile storage elements that provides a storage area specified by the I/O command as an access destination, a response including a delay occurrence potential notification to the storage controller, the delay occurrence potential notification indicating that, although a possibility of delay in I/O processing exists, continued use of the one of the plurality of storage devices is possible.

### CLAIM OF PRIORITY

The present application claims priority from Japanese patent application JP 2022-43449 filed on Mar. 18, 2022, the content of which is hereby incorporated by reference into this application.

### BACKGROUND OF THE INVENTION

This invention relates to a storage system in which storage devices including non-volatile storage elements are installed.

Introduction of a storage system in which storage devices including non-volatile storage elements such as NAND flash memories is being advanced. Herein, “storage device” means a storage device including a non-volatile storage element.

In recent years, an increase in capacity of a storage device is desired as an amount of data handled grows larger. Known methods of increasing the capacity of a storage device include an increase of non-volatile storage elements in number and utilization of multi-level cell technology.

Whichever method out of an increase of non-volatile storage elements in number and utilization of multi-level cell technology is used, there is a problem of a rise in failure rate of a storage device, and a technology for dealing with the problem is required. In WO 2016/030992 A1, there is described notifying a failure site to a storage controller by a device controller of a storage device.

### SUMMARY OF THE INVENTION

According to the technology as described in WO 2016/030992 A1, the failure site is blocked to enable continued use of the storage device. A storage system as described in WO 2016/030992 A1 executes, along with the blocking, restoration processing for restoring data stored in the failure site. During the execution of the restoration processing, performance of I/O processing drops with respect to the storage device containing the failure site, and response to a host computer coupled to the storage system is consequently delayed. There is a possibility that the storage system may block the storage device low in I/O performance in order to prevent the delay in response to the host computer, and, when blocked, the storage device cannot be kept used.

It is an object of this invention to provide a technology for enabling, instead of blocking a storage device low in performance of I/O processing due to execution of restoration processing, continued use of the storage device.

A representative example of the present invention disclosed in this specification is as follows: a storage system comprises a plurality of storage devices and at least one storage controller. The plurality of storage devices each include a plurality of non-volatile storage elements. The plurality of storage devices each is configured to: receive an I/O command from the at least one storage controller; and transmit, when one of the plurality of storage devices detects a failure in one of the plurality of non-volatile storage elements that provides a storage area specified by the I/O command as an access destination, a response including a delay occurrence potential notification to the at least one storage controller, the delay occurrence potential notification indicating that, although a possibility of delay in I/O processing exists, continued use of the one of the plurality of storage devices is possible.

According to the at least one embodiment of this invention, the storage system enables continued use of the storage device low in performance of I/O processing due to execution of restoration processing instead of blocking the storage device.

### BRIEF DESCRIPTION OF THE DRAWINGS

The present invention can be appreciated by the description which follows in conjunction with the following figures, wherein:

FIG. 1 is a diagram for illustrating an example of a system in a first embodiment of this invention;

FIG. 2 is a table for showing an example of a management table held by a device controller in the first embodiment;

FIG. 3 is a sequence diagram for illustrating processing executed by a storage system of the first embodiment; and

FIG. 4 is a flow chart for illustrating processing executed by a storage controller in the first embodiment.

### DETAILED DESCRIPTION

Now, description is given of at least one embodiment of this invention referring to the drawings. It should be noted that this invention is not to be construed by limiting the invention to the content described in the following at least one embodiment. A person skilled in the art would easily recognize that specific configurations described in the following at least one embodiment may be changed within the scope of the concept and the gist of this invention.

In configurations of the at least one embodiment of this invention described below, the same or similar components or functions are denoted by the same reference numerals, and a redundant description thereof is omitted here.

Notations of, for example, “first”, “second”, and “third” herein are assigned to distinguish between components, and do not necessarily limit the number or order of those components.

The position, size, shape, range, and others of each component illustrated in, for example, the drawings may not represent the actual position, size, shape, range, and others in order to facilitate understanding of this invention. Thus, this invention is not limited to the position, size, shape, range, and others disclosed in, for example, the drawings.

### First Embodiment

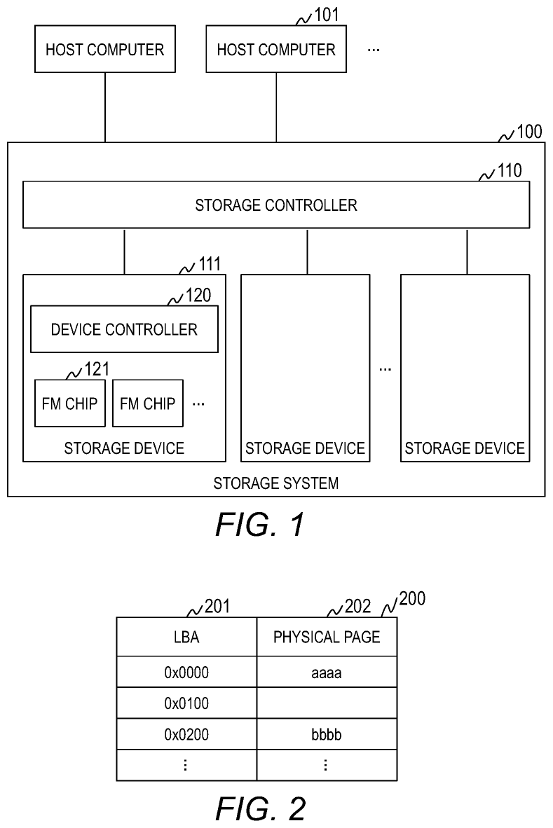

FIG. 1 is a diagram for illustrating an example of a system in a first embodiment of this invention.

The system includes a storage system 100 and a plurality of host computers 101. The host computer 101 is coupled to the storage system 100 through a wide area network (WAN), a local area network (LAN), a storage area network (SAN), or other such network.

This invention is not limited by the number of host computers 101 coupled to the storage system 100.

The host computers 101 are computers that use the storage system 100. The host computers 101 write data to and read data from volumes provided by the storage system 100.

The storage system 100 includes a storage controller 110 and storage devices 111. In FIG. 1, there is one storage controller 110, but the storage system 100 may include two or more storage controllers. The storage system 100 creates a redundant arrays of inexpensive disks (RAID) group from a plurality of storage devices 111, creates volumes from the RAID group, and provides the volumes to the host computers 101. The volumes are, for example, LDEVs. The volumes may each include a plurality of LDEVs.

The storage controller 110 executes overall control of the storage system 100. For example, the storage controller 110 executes management of the RAID group, management of the volumes, and control of I/O processing. The storage controller 110 includes a processor, a memory, a host IF, and a drive IF (not shown). The memory stores a program for controlling the storage system 100, and is also used as a cache memory.

The storage devices 111 are storage devices including non-volatile storage elements such as solid state drives (SSDs). The storage devices 111 each include a device controller 120 and a plurality of flash memory (FM) chips 121.

The device controller 120 of each of the storage devices 111 controls its own storage device. The device controller 120 includes a processor and a memory (not shown) as well as an IF (not shown) for coupling to the storage controller 110 and an IF (not shown) for coupling to the FM chips 121. The device controller 120 manages an association relationship between a logical address space provided to the storage system 100 and a physical address on one of the FM chips 121. The logical address space is managed on, for example, a page-by-page basis. The storage devices 111 delete data in units of block, which includes a plurality of pages, and execute data write and data read on a page-by-page basis.

The FM chips 121 each include a plurality of memory cells. Each memory cell stores one bit of data or a plurality of bits of data. The device controller 120 divides storage areas of the FM chips 121 into pages of a predetermined size, and manages the pages.

FIG. 2 is a table for showing an example of a management table 200 held by the device controller 120 in the first embodiment.

The management table 200 is information for managing the association relationship between a logical address space and a physical address. The management table 200 holds entries each including an LBA 201 and a physical page 202. Fields included in each of the entries are not limited to those mentioned above. For example, the entries may each include a field for storing a page number of the logical address space.

The LBA 201 is a field for storing a head address (logical block address) of a page of the logical address space. The physical page 202 is a field for storing identification information of a page in the FM chips 121.

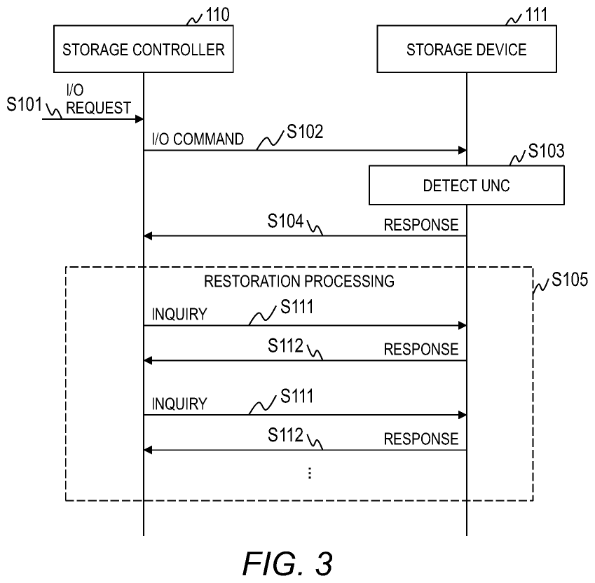

FIG. 3 is a sequence diagram for illustrating processing executed by the storage system 100 of the first embodiment.

The storage controller 110 receives an I/O request from one of the host computers 101 (Step S101), and then transmits an I/O command to one of the storage devices 111 (Step S102). The I/O command includes an LBA.

The device controller 120 of the one of the storage devices 111 executes I/O processing for a physical page that is associated with the LBA included in the I/O command, based on the management table 200. It is assumed here that an uncorrectable error (UNC) is detected in the I/O processing. When a UNC is detected (Step S103), the device controller 120 transmits, to the storage controller 110, a response containing a “delay occurrence potential notification,” which informs that, although there is a possibility of delay in I/O processing, the one of the storage devices 111 that includes one of the FM chips 121 in which the UNC has been detected can be kept used (Step S104). In this step, the device controller 120 generates address information storing the LBA that is associated with the physical page on which the UNC has been detected, and includes the address information in the response. The device controller 120 may use a publicly-known technology such as the technology of WO 2016/030992 A1 to identify a failure site and include an LBA associated with the failure site in the address information.

The storage controller 110 shifts to a mode for tolerating a delay in I/O processing with respect to the one of the storage devices 111 that includes the physical page associated with the LBA. As described later, the storage controller 110 executes delay avoiding I/O processing in order to suppress a delay in I/O processing with respect to the one of the storage devices 111 from which the delay occurrence potential notification has been transmitted.

When receiving the response, the storage controller 110 executes restoration processing (Step S105). The storage controller 110 restores data by using, for example, parity data of the storage devices 111 forming the RAID group. Contents of the restoration processing do not limit this invention. The restoration processing can be any processing as long as data stored on the physical page on which the UNC has been detected can be restored.

During the execution of the restoration processing, the storage controller 110 cyclically issues an inquiry to the one of the storage devices 111 in which the UNC has been detected about whether the failure has been solved (Step S111), An example of the inquiry is one using a Log Sense command. Here, the failure being solved means detection of no UNC in the I/O processing for the physical page associated with the LBA, that is, completion of the restoration processing of the data. The cycle of the inquiry may be set to any length.

The device controller 120 of the one of the storage devices 111 accesses the LBA associated with the physical page on which the UNC has been detected, and transmits a response containing a result of UNC detection to the storage controller 110 (Step S112). In a case in which a UNC is detected, the device controller 120 may generate address information containing an LBA that is associated with the physical page on which the UNC is detected, and include the address information in the response.

When the restoration processing is finished, the storage controller 110 stops issuing the inquiry.

The one of the storage devices 111 may take the lead in the execution of the restoration processing. For example, in a case in which data redundancy is ensured between the FM chips 121, the device controller 120 can restore data in the one of the storage devices 111 that is its own storage device. In this case, the storage controller 110 can figure out that the failure has been solved, that is, the restoration processing has been finished, based on a response to an inquiry to the one of the storage devices 111.

When the number of LBAs contained in the address information is greater than a threshold value, or when the failure cannot be solved within a predetermined period, the storage controller 110 may execute blocking processing in which the one of the storage devices 111 is removed from the RAID group, and another one of the storage devices 111 is newly added to the RAID group.

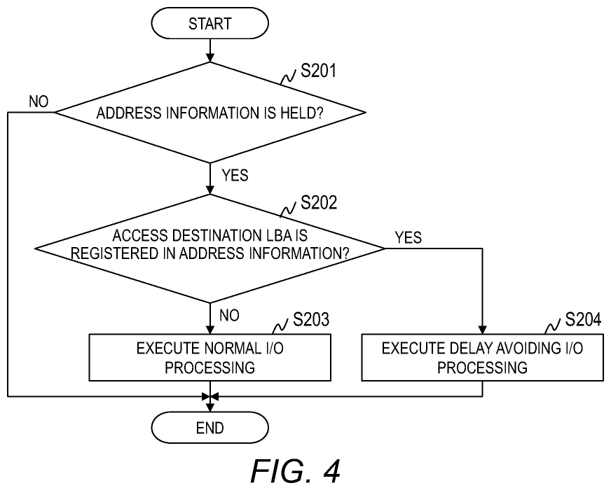

FIG. 4 is a flow chart for illustrating processing executed by the storage controller 110 in the first embodiment.

The storage controller 110 receives an I/O request, and then determines whether address information is held (Step S201).

When no address information is held, the storage controller 110 executes normal I/O processing (Step S203).

When address information is held, the storage controller 110 determines whether an LBA that is an access destination of the I/O request is registered in the address information (Step S202).

When the LBA that is the access destination of the I/O request is not registered in the address information, the storage controller 110 executes normal I/O processing (Step S203).

When the LBA that is the access destination of the I/O request is registered in the address information, the storage controller 110 executes the delay avoiding I/O processing (Step S204). For example, in a case in which the I/O request is a request to read data, the storage controller 110 reads the data (correction read) out of another one of the storage devices 111 in the RAID group to which one of the storage devices 111 that includes a physical page on which a UNC has been detected belongs. In a case in which the I/O request is a request to write data, the storage controller 110 writes the data in the cache and, after detecting that the failure has been solved, writes the data to the one of the storage devices 111.

The execution of the delay avoiding I/O processing suppresses access to the one of the storage devices 111 that includes the physical page on which the UNC has occurred, and a delay in I/O processing can thus be reduced.

As described above, according to the at least one embodiment of this invention, one of the storage devices 111 that has detected a UNC transmits the delay occurrence potential notification to the storage controller 110, to thereby avoid blocking of the one of the storage devices 111 due to a delay in I/O processing. This enables continued use of the one of the storage devices 111, and can accordingly reduce a frequency of replacing the one of the storage devices 111. The one of the storage devices 111 also notifies an LBA associated with a physical page on which the UNC has been detected to the storage controller 110, and the storage controller 110 can thus suppress a delay in I/O processing executed at the LBA.

This invention is not limited to the at least one embodiment described above, and encompasses various modification examples. For example, the at least one embodiment has described this invention in detail for the ease of understanding, and this invention is not necessarily limited to a mode that includes all of the configurations described above. A part of the configuration of one embodiment may be replaced with the configuration of another embodiment, and the configuration of one embodiment may be used in combination with the configuration of another embodiment. In each embodiment, another configuration may be added to, deleted from, or replace a part of the configuration of one embodiment.

What is claimed is:

1. A storage system, comprising a plurality of storage devices and at least one storage controller,
the plurality of storage devices each including a plurality of non-volatile storage elements,
the plurality of storage devices each being configured to:
receive an I/O command from the at least one storage controller; and
transmit, when one of the plurality of storage devices detects a failure in one of the plurality of non-volatile storage elements that provides a storage area specified by the I/O command as an access destination, a response including a delay occurrence potential notification to the at least one storage controller, the delay occurrence potential notification indicating that, although a possibility of delay in I/O processing exists, continued use of the one of the plurality of storage devices is possible.

2. The storage system according to claim 1, wherein the at least one storage controller is configured to cyclically issue, during execution of restoration processing of data stored in the one of the plurality of non-volatile storage elements that is detected to have the failure, an inquiry about whether the failure is solved to the one of the plurality of storage devices from which the response is transmitted.

3. The storage system according to claim 2,
wherein the one of the plurality of storage devices is configured to generate address information storing an address of a specific storage area provided by the one of the plurality of non-volatile storage elements that is detected to have the failure, and transmit the address information to the at least one storage controller, and
wherein the at least one storage controller is configured to:
determine, when an I/O request is received, whether the I/O request involves access to the specific storage area by referring to the address information; and
execute, when access to the specific storage area is involved, delay avoiding I/O processing for suppressing a delay in I/O processing.

4. The storage system according to claim 3, wherein the at least one storage controller is configured to execute processing of blocking the one of the plurality of storage devices in one of a case in which the address information includes the number of addresses that is greater than a threshold value, or a case in which a notification notifying that the failure is solved is not received within a predetermined period since reception of the response.

5. A method of controlling a storage system,
the storage system including a plurality of storage devices and at least one storage controller,
the plurality of storage devices each including a plurality of non-volatile storage elements,
the method of controlling a storage system including:
receiving, by one of the plurality of storage devices, an I/O command from the at least one storage controller; and
transmitting, by the one of the plurality of storage devices, when a failure is detected in one of the plurality of non-volatile storage elements that provides a storage area specified by the I/O command as an access destination, a response including a delay occurrence potential notification to the at least one storage controller, the delay occurrence potential notification indicating that, although a possibility of delay in I/O processing exists, continued use of the one of the plurality of storage devices is possible.

6. The method of controlling a storage system according to claim 5, further including cyclically issuing, by at least one storage controller, during execution of restoration processing of data stored in the one of the plurality of non-volatile storage elements that is detected to have the failure, an inquiry about whether the failure is solved to the one of the plurality of storage devices from which the response is transmitted.

7. The method of controlling a storage system according to claim 6, further including:
generating, by the one of the plurality of storage devices, address information storing an address of a specific storage area provided by the one of the plurality of non-volatile storage elements that is detected to have the failure, and transmitting the address information to the at least one storage controller;
determining, by the at least one storage controller, when an I/O request is received, whether the I/O request involves access to the specific storage area by referring to the address information; and
executing, by the at least one storage controller, when access to the specific storage area is involved, delay avoiding I/O processing for suppressing a delay in I/O processing.

8. The method of controlling a storage system according to claim 7, further comprising executing, by the at least one storage controller, processing of blocking the one of the plurality of storage devices in one of a case in which the address information contains the number of addresses that is greater than a threshold value, or a case in which a notification notifying that the failure is solved is not received within a predetermined period since reception of the response.
